(19) United States
(12) Patent Application Publication
(10) Pub. No.: US 2026/0230283 A1
(43) Pub. Date: Aug. 6, 2026

(54) METHODS ON PERFORMANCE MONITORING FOR ARTIFICIAL INTELLIGENCE (AI) / MACHINE LEARNING (ML)

(71) Applicant: InterDigital Patent Holdings, Inc., Wilmington, DE (US)

(72) Inventors: Young Woo Kwak, Woodbury, NY (US); Yugeswar Deenoo Narayanan Thangaraj, Chalfont, PA (US); Haseeb Ur Rehman, Winnipeg (CA); Dylan Watts, Montreal (CA); Patrick Tooher, Montreal (CA); Oumer Teyeb, Montreal (CA); Prasanna Herath, Laval (CA)

(73) Assignee: InterDigital Patent Holdings, Inc., Wilmington, DE (US)

(21) Appl. No.: 19/044,378

(22) Filed: Feb. 3, 2025

(51) Int. Cl. H04L 5/00; H04B 7/06; H04B 17/318

(52) U.S. Cl. CPC H04L 5/0057; H04B 7/0626; H04B 17/328; H04L 5/0048

(57) ABSTRACT

A wireless transmit/receive unit (WTRU) may receive configuration information to determine beam prediction accuracy. The configuration information may include an indication associated with at least one transmission configuration indication (TCI) state, a first channel state information (CSI) report configuration associated with a first set of reference signal (RS) resources to predict measurements, and/or a second CSI report configuration associated with monitoring a second set of RS resources. The WTRU may activate the second set of RS resources to monitor based at least on the indication of the at least one TCI state. The WTRU may start a performance evaluation counter to determine the beam prediction accuracy. The WTRU may predict the measurement(s) in accordance with the first CSI report configuration. The WTRU may determine the beam prediction accuracy based on the configuration information, the performance evaluation counter, and/or the first and/or the second set of RS resources.

### BACKGROUND

Artificial intelligence may be referred to as the behaviour exhibited by machines. Such behaviour may, for example, mimic cognitive functions to sense, reason, adapt, and/or act.

Machine learning may refer to a type of algorithms that address one or more problems based on learning through experience and/or data, without (e.g., explicitly) being programmed (e.g., configuring set of rules). Machine learning can be considered as a subset of A1. Different machine learning paradigms may be envisioned based on the nature of data and/or feedback available to the learning algorithm. For example, a supervised learning approach may include learning a function that maps input to an output based on labelled training example, where each training example may be a pair including input and the corresponding output. For example, unsupervised learning approach may include detecting patterns in the data with no pre-existing labels. For example, reinforcement learning approach may include performing a sequence of actions in an environment to maximize the cumulative reward. In examples, it may be possible to apply machine learning algorithms using a combination and/or interpolation of the approaches described herein. For example, semi-supervised learning approach may use a combination of a small amount of labelled data with a large amount of unlabelled data during training. In this regard, semi-supervised learning may fall between unsupervised learning (e.g., with no labelled training data) and supervised learning (e.g., with only labelled training data).

### SUMMARY

A wireless transmit/receive unit (WTRU) may activate monitoring reference signal (RS) resource set(s) based on an indicated transmission configuration indication (TCI) state and/or may perform prediction accuracy evaluation of inference channel state information (CSI) report configuration based on one or more strongest beams from the inference CSI report and/or activated monitoring RS resource set. Embodiments described herein may include activation of monitoring RS resource set associated with the indicated TCI state. Embodiments described herein may include a performance evaluation counter. Embodiments described herein may include a determination of beam prediction accuracy based on inference result(s), measurement(s), and/or metric(s).

A wireless transmit/receive unit (WTRU) may receive configuration information to determine beam prediction accuracy associated with an artificial intelligence or machine learning (AI/ML) model at the WTRU. The configuration information may include an indication associated with at least one transmission configuration indication (TCI) state, a first channel state information (CSI) report configuration associated with a first set of reference signal (RS) resources to predict measurements, and/or a second CSI report configuration associated with monitoring a second set of RS resources. The WTRU may activate the second set of RS resources to monitor, for example, based at least on the indication of the at least one TCI state. The WTRU may start a performance evaluation counter to determine the beam prediction accuracy. The WTRU may predict the measurement(s) for at least one reporting and/or measurement instance, for example, in accordance with the first CSI report configuration. The WTRU may determine the beam prediction accuracy based on the configuration information, the performance evaluation counter, the first set of RS resources, and/or the second set of RS resources. The WTRU may send an indication of the beam prediction accuracy based at least on the second CSI report configuration and/or the performance evaluation counter.

A plurality of RS resource sets may include the second set of RS resources. The WTRU may select the second set of RS resources from the plurality of RS resource sets to activate the second set of RS resources to monitor. The second set of RS resources may be associated with the indication associated with the at least one TCI state.

The beam prediction accuracy may represent a ratio of correctly predicted measurements to performed actual measurements for each reporting or measurement instance of the at least one reporting and/or measurement instance.

The WTRU being configured to send the indication of the beam prediction accuracy may include the WTRU being configured to send an indication of the ration of correctly predicted measurements to performed actual measurements for each reporting and/or measurement instance of the at least one reporting and/or measurement instance.

The performed actual measurements may include actual layer-one (L1) reference signal received power (RSRP) measurements. The predicted measurements may include predicted L1-RSRP measurements. The WTRU being configured to determine the beam prediction accuracy may include the WTRU being configured to determine whether each actual L1-RSRP measurement is within a tolerance of each predicted L1-RSRP measurement for each reporting and/or measurement instance of the at least one reporting and/or measurement instance when the performance evaluation counter is greater than threshold and the set of RS resources fails to comprise a RS resource indicated by the one or more sets of inference information.

The performance evaluation counter may be started and/or restarted based on one or more of a radio resource configuration, reporting information, an activated CSI report configuration, and/or an activated RS resource set.

When the performance evaluation counter is greater than threshold and the set of RS resources includes a RS resource indicated by the first CSI report configuration (e.g., one or more sets of inference information), for example, the WTRU may predict a strongest beam based on the predicted measurements. The beam prediction accuracy may include a first accuracy. The first accuracy may be determined when a beam with a highest measured value of the RS resource set is the strongest beam.

When the performance evaluation counter is greater than threshold and the set of RS resources include a RS resource indicated by the first CSI report configuration (e.g., one or more sets of inference information), for example, the WTRU may predict at least one predicted beam based on the predicted measurements. The beam prediction accuracy may include a second accuracy. The second accuracy may be determined when the at least one predicted beam includes a beam with highest measured value of layer one (L1)-reference signal received power (RSRP).

The configuration information may indicate a plurality of strong beams. The beam prediction accuracy may include a third accuracy, a fourth accuracy, and/or a fifth accuracy When the performance evaluation counter is greater than threshold and the set of RS resources includes a RS resource indicated by the first CSI report configuration (e.g., one or more sets of inference information), for example, the WTRU may predict at least one predicted beam based on the predicted measurement(s). The third, fourth, and/or fifth accuracy may be determined based on the plurality of strong beams and/or the at least one predicted beam.

When the performance evaluation counter is greater than threshold and the set of RS resources includes a RS resource indicated by the first CSI report configuration (e.g., one or more sets of inference information), for example, the WTRU may predict at least one predicted beam based on the predicted measurements. The beam prediction accuracy may be determined based on a determination that a beam comprised in the at least one predicted beam comprises a highest layer one (L1)-reference signal received power (RSRP) value among the L1-RSRP values associated with the at least one predicted beam. The highest L1-RSRP value may be within a tolerance of a highest L1-RSRP value associated with the set of RS resources.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

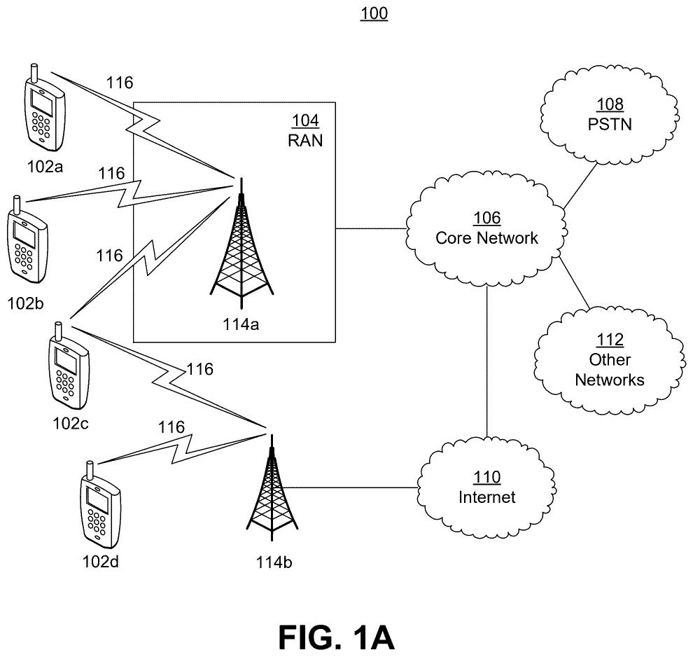

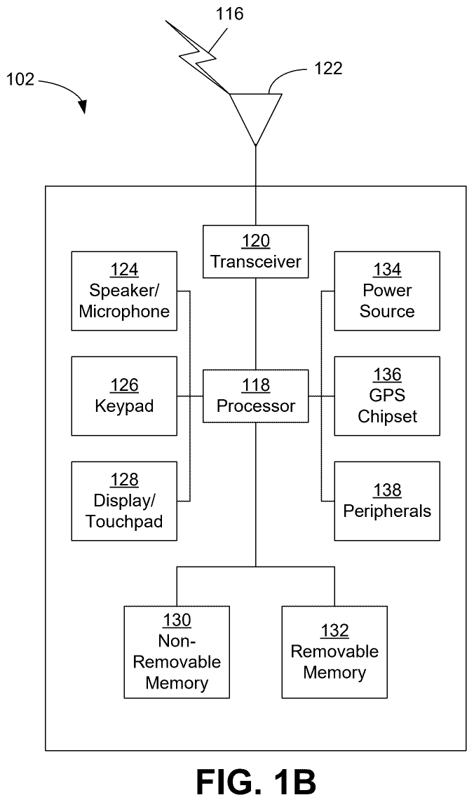

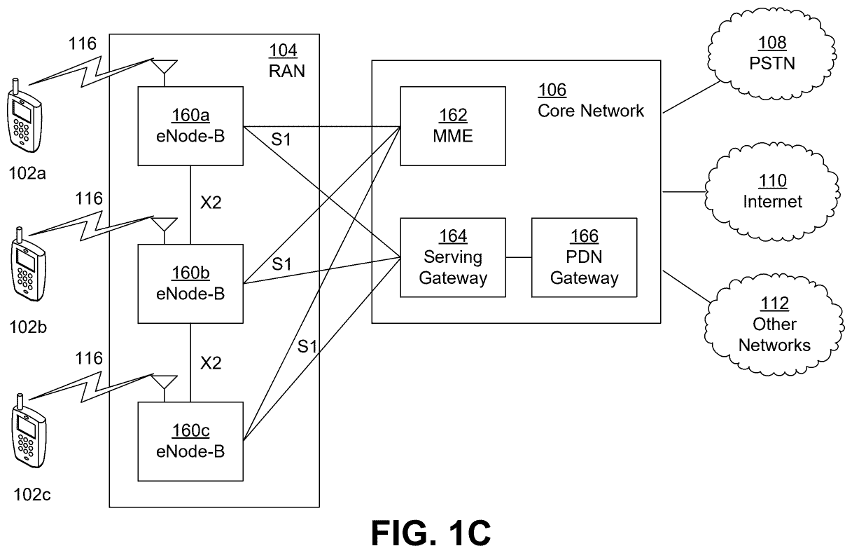

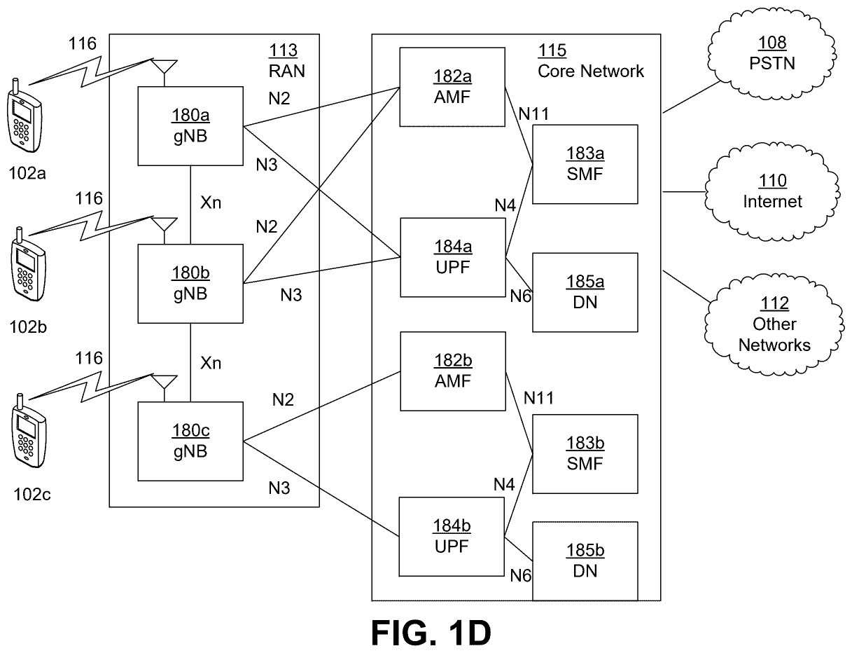

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHZ, 80 MHZ, and/or 160 MHz wide channels. The 40 MHZ, and/or 80 MHZ, channels may be formed by combining contiguous 20 MHz channels. A 160 MHZ channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHZ. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI)/machine learning (ML) for NR air interface may be discussed herein, which may include one or more of the following objectives for framework and/or model identification. Beam management may include downlink (DL) transaction (Tx) beam prediction for (e.g., both) wireless transmit/receive unit (WTRU)-sided model and/or network (NW)-sided model including RAN1 and/or RAN2. For example, beam management may include spatial-domain DL Tx beam prediction for Set A of beams based on measurement results of Set B of beams (BM-Case1). For example, beam management may include temporal DL Tx beam prediction for Set A of beams based on the historic measurement results of Set B beams (BM-Case2). For example, beam management may specify signaling and/or mechanism(s) to facilitate life cycle management (LCM) operation(s) specific to the beam management use case(s). For example, beam management may include enabling one or more methods to ensure consistency between training and inference regarding NW-side additional conditions (e.g., if identified) for inference at the WTRU. Beam management may include striving for a framework design to support (e.g., both) BM-Case1 and/or BM-Case2.

Embodiments described herein may include DL Tx beam for (e.g., both) WTRU-sided model and/or NW-sided model in (e.g., both) spatial domain and/or temporal domain. A separate CSI report configuration for WTRU side performance monitoring in addition to a CSI report configuration for inference reporting may be supported. At least for the monitoring Type 1 option 2 of WTRU-side model monitoring (when applicable), support to reuse CSI framework for the configuration for monitoring result report in L1 signaling: dedicated resource set(s) for monitoring and/or report configuration for monitoring may be configured in a dedicated CSI report configuration used for monitoring. An identification (ID) of an inference report configuration may be configured in the configuration for monitoring to link the inference report configuration and monitoring report configuration. How to identify the connection between reference signals (RSs) in the resource set(s) for monitoring and set A beams may be addressed herein. Whether to support one or more (e.g., all) of the combination(s) on time domain behavior of the reportConfigType for inference report and/or the reportConfigType for monitoring report may be addressed herein. Timing related issued may be addressed herein. A WTRU may measure the dedicated resource set(s) for monitoring.

Embodiments described herein may include a beam accuracy indicator.

For beam management (BM)-Case 1 and/or at least for BM-Case2 with single time instance in a report with a WTRU-sided artificial intelligence (AI)/machine learning (ML) model, for option 2 (e.g., WTRU-assisted performance monitoring), embodiments may include another (e.g., new) quantity (e.g., beam accuracy indicator (BAI) for beam prediction accuracy in the CSI report for monitoring. For example, BAI=Nₚ, the accuracy may correspond to the BAI is Nₚ/N. The size of CSI field may be associated with the BAI is [log₂ N]. Nₚ may be the number of the reported inference result(s) linked with performance monitoring instance(s) to (out of N) for which the following statement(s) may hold with potentially downselection (at least for the case that full set of Set A can be measured). Option 1 (Top-1/1) may include the Top-1 beam with largest measured value of the resource set(s) for monitoring is Top-1 predicted beam. Option 2 (1/Top-K) may include the Top-1 beam with largest measured value of layer 1 (L1)-reference signal received power (RSRP) of the resource set(s) for monitoring is one of the Top-K predicted beams. K>1, and/or K may be equal to the number of reported predicted beam configured by inference report configuration. Option 3 (Top-K/M) may include the Top-K predicted beams are among Top M beam(s) with largest M measured value(s) of L1-RSRP(s) of the resource set(s) for monitoring. For example, K may equal 1, M may be configured, and/or K<=M. Option 4 (strongest of Top-K/1 with margin) may include the beam with largest measured value of L1-RSRP of Top-K predicted beams is within a margin X dB of largest measured value of L1-RSRP of the resource set(s) for monitoring. For example, X=0, 1, and/or one or more other values. For example, K=1 and/or K may be equal to the number of reported predicted beam configured by inference report configuration, and/or K may be include one or more other values. One or more of the options described herein may be further defined. The options described herein may not preclude one or more other options. The options described herein may be included in monitoring set(s). N may be the number of the reported inference result(s) linked with performance monitoring instance(s). Embodiments described herein may address how to link an inference result (e.g., in the inference report) to a performance monitoring instance. Embodiments described herein may address whether to exclude some linked reported inference result(s)/monitoring instance(s).

In AI/ML CSI reporting (e.g., with WTRU side AI/ML model), a WTRU may predict beam related information (e.g., strongest beam(s) and/or predicted beam quality(ies) based on measurements. An AI/ML model can be generalized for one or more use cases and/or scenarios; each AI/ML model may fail in one or more cases which are not generalized. To detect the failure, performance monitoring of an AI/ML model may be included. To monitor performance (e.g., efficiently), one or more of the following may be addressed: how to measure predicted beams; how to determine correct and/or incorrect (e.g., metrics); and/or how to indicate the evaluated result(s).

There may be no beam prediction procedure; a gNB may monitor performance of CSI reporting based on physical downlink shared channel (PDSCH) block error rate (BLER) on the WTRU reported information. Additionally or alternatively, the gNB may configure beam failure recovery procedure to monitor and/or detect potential beam failure(s) and/or corresponding recovery procedure(s). Embodiments described herein may include how a WTRU (e.g., efficiently) supports performance monitoring for AI/ML based prediction.

A WTRU may activate monitoring RS resource set based on an indicated TCI state and/or may perform prediction accuracy evaluation of inference CSI report configuration based on one or more strongest beams from the inference CSI report and/or activated monitoring RS resource set.

A WTRU may receive configuration information. For example, WTRU may receive configuration information to determine beam prediction accuracy associated with an artificial intelligence or machine learning (AI/ML) model at the WTRU. The configuration information may include an indication associated with at least one transmission configuration indication (TCI) state, a first channel state information (CSI) report configuration associated with a first set of reference signal (RS) resources to predict measurements, and/or a second CSI report configuration associated with monitoring a second set of RS resources. The configuration may include one or more (e.g., two or more) TCI states. The configuration information may include one or more (e.g., two or more) CSI reporting configurations. A first CSI reporting configuration may include at least one or more of the following parameters: a RS resource set for set A; a RS resource set for set B; ReportQuantity; and/or a transmission type (e.g., periodic, semi-static, and/or aperiodic). For example, the first CSI report configuration may indicate one or more RS resources (e.g., as a result of inference). A second CSI reporting configuration may include at least one or more of the following parameters for monitoring. For example, the second CSI report configuration can indicate a number of RS resource sets. For example, in high speed case, beam change can be faster than lower speed case; the number of candidates may (e.g., want to) be extended. This may be dynamically determined by the WTRU; the gNB may not have information. To decode the information (e.g., selected candidates), the gNB may know how many resource sets are used (e.g., first). A second CSI reporting configuration may include one or more monitoring RS resource sets. Each monitoring RS resource set may be associated with a group of TCI states. For example, a plurality of RS resource sets may include the second set of RS resources. The WTRU may select the second set of RS resources from the plurality of RS resource sets to activate the second set of RS resources to monitor. The second set of RS resources may be associated with the indication associated with the at least one TCI state. A second CSI reporting configuration may include a ReportQuantity. A second CSI reporting configuration may include a transmission type (e.g., WTRU triggered, periodic, semi-static, and/or aperiodic). A beam prediction quality threshold may be configured, for example, if the transmission type is WTRU triggered.

The WTRU may receive an indication of a TCI state for transmission and/or reception (e.g., one or more of physical downlink control channel (PDCCH), physical downlink shared channel (PDSCH), physical uplink control channel (PUCCH), and/or physical uplink shared channel (PUSCH). For example, the indication may indicate the TCI state to be applied for PDCCH, PDSCH, PUSCH, and/or PUCCH.

The WTRU may activate a monitoring RS resource set associated with the indicated TCI state. For example, the WTRU may activate the second set of RS resources to monitor, for example, based at least on the indication of the at least one TCI state. For example, one or more mechanism(s) may be used to activate a RS resource set for semi-persistent CSI-RS. When the RS resource set is deactivated, for example, the RS resource set may not be transmitted/used. Based on the activation (e.g., by receiving MAC CE), the RS resource set may be activated and/or received by the WTRU. Embodiments described herein may include tying the activation process with a strongest beam (e.g., the indicated TCI state) to reduce redundant procedure, for example, instead of (e.g., explicitly, separately) activating the RS resource set.

The WTRU may initiate a performance evaluation counter (e.g., 0). For example, the WTRU may start a performance evaluation counter to determine the beam prediction accuracy. The performance evaluation counter may be started and/or restarted based on one or more of a radio resource configuration, reporting information, an activated CSI report configuration, and/or an activated RS resource set. The performance evaluation counter may be a count on the number of inference instances that have been reported. Once the WTRU reports a number of inference instances above the threshold, for example, the WTRU may predict accuracy evaluation results (e.g., as described herein).

The WTRU may indicate one or more sets of inference information based on the first CSI reporting configuration. The WTRU may increase the performance evaluation counter when the WTRU indicates the one or more sets of inference information. For example, a WTRU may send a CSI report configuration to the network with the inferred and/or predicted CSI based on the first CSI report configuration.

In accordance with the first CSI report configuration, the WTRU may predict measurements for at least one reporting and/or measurement instance.

If the performance evaluation counter exceeds a performance evaluation counter threshold, for example, the WTRU may report prediction accuracy evaluation results (e.g., WTRU triggered) based on the one or more sets of inference information.

If the monitoring RS resource set (and/or the RS resource set for set B) (e.g., activated RS resource set among the configured resource set(s) by the second CSI report configuration) includes a RS resource indicated by the first CSI report configuration (e.g., one or more sets of inference information), for example, the WTRU may perform evaluation based on one or more of the following. The WTRU may perform evaluation based on a first option (Top-1/1). The Top-1 beam(s) with the largest measured value of the resource set(s) for monitoring may be Top-1 predicted beam(s). When the performance evaluation counter is greater than threshold and the (e.g., second) set of RS resources includes a RS resource indicated by the first CSI report configuration (e.g., one or more sets of inference information), for example, the WTRU may predict a strongest beam based on the predicted measurements. The beam prediction accuracy may include a first accuracy. The first accuracy may be determined when a beam with a highest measured value of the RS resource set is the strongest beam. The WTRU may perform evaluation based on a second option (1/Top-K). The Top-1 beam with the largest measured value of L1-RSRP of the resource set(s) for monitoring may be one of the Top-K predicted beams. When the performance evaluation counter is greater than threshold and the (e.g., second) set of RS resources include a RS resource indicated by the first CSI report configuration (e.g., one or more sets of inference information), for example, the WTRU may predict at least one predicted beam based on the predicted measurements. The beam prediction accuracy may include a second accuracy. The second accuracy may be determined when the at least one predicted beam includes a beam with highest measured value of layer one (L1)-reference signal received power (RSRP). The WTRU may perform evaluation based on a third option (Top-K/M). The Top-K predicted beams may be among Top M beam(s) with largest M measured value(s) of L1-RSRP(s) of the resource set(s) for monitoring. The WTRU may determine different evaluation performance based on the number of Top-K predicted beams, which may be among Top M beams. K and M may be different. In examples, K can be 5 and M can be 10. In examples, if one beam is among Top M beams, the accurate inference may be ¼ accurate. For example, if two beams are among Top M beams, the accurate inference may be ½ accurate. For example, if one or more (e.g., all) beams are among Top M beams, the accurate inference may be completely accurate (e.g., 4/4 accurate). The WTRU may perform evaluation based on a fourth option (strongest of Top-K/1 with margin). The beam with the largest measured value of L1-RSRP of Top-K predicted beams may be within a margin of X dB of largest measured value of L1-RSRP of the resource set(s) for monitoring.

If the monitoring RS resource set (and/or the RS resource set for Set B) (e.g., activated RS resource set among the configured resource set(s) by the second CSI report configuration) does not include the RS resource indicated by the first CSI report configuration (e.g., one or more sets of inference information), for example, the WTRU may perform evaluation based on one or more of the following. The WTRU may perform evaluation based on measured L1-RSRP(s) within X dB margin from prediction RSRP(s) of the monitoring RS resource set. For example, measured L1-RSRP(S) and/or predicted RSRP(s) may be from largest and/or minimum measurement and/or prediction beam and/or average of one or more (e.g., all) beams. If satisfied (e.g., based on measured L1-RSRP(s) within X dB margin from prediction RSRP(s) of the monitoring RS resource set), the accurate information may be ½ accurate.

The WTRU may determine prediction accuracy of the first CSI report configuration based on, for example, the determined accuracy (e.g., for each inference instance). For example, the WTRU may determine prediction accuracy of the first CSI report configuration based on a sum of inference accuracy divided by the number of inference reporting instances. The WTRU may determine the beam prediction accuracy based on the configuration information, the performance evaluation counter, the first set of RS resources, and/or the second set of RS resources. The beam prediction accuracy may represent a ratio of correctly predicted measurements to performed actual measurements for each reporting or measurement instance of the at least one reporting and/or measurement instance.

The WTRU may indicate the determine evaluated prediction accuracy (e.g., to a gNB) based on the second CSI reporting configuration. For example, the WTRU may send an indication of the beam prediction accuracy based at least on the second CSI report configuration and/or the performance evaluation counter. The WTRU being configured to send the indication of the beam prediction accuracy may include the WTRU being configured to send an indication of the ration of correctly predicted measurements to performed actual measurements for each reporting and/or measurement instance of the at least one reporting and/or measurement instance.

Embodiments described herein may include how the WTRU (e.g., efficiently) monitors AI/ML based prediction.

Artificial intelligence may be referred to as the behaviour exhibited by machines. Such behaviour may, for example, mimic cognitive functions to sense, reason, adapt, and/or act.

Machine learning may refer to a type of algorithms that address one or more problems based on learning through experience and/or data, without (e.g., explicitly) being programmed (e.g., configuring set of rules). Machine learning can be considered as a subset of AI. Different machine learning paradigms may be envisioned based on the nature of data and/or feedback available to the learning algorithm. For example, a supervised learning approach may include learning a function that maps input to an output based on labelled training example, where each training example may be a pair including input and the corresponding output. For example, unsupervised learning approach may include detecting patterns in the data with no pre-existing labels. For example, reinforcement learning approach may include performing a sequence of actions in an environment to maximize the cumulative reward. In examples, it may be possible to apply machine learning algorithms using a combination and/or interpolation of the approaches described herein. For example, semi-supervised learning approach may use a combination of a small amount of labelled data with a large amount of unlabelled data during training. In this regard, semi-supervised learning may fall between unsupervised learning (e.g., with no labelled training data) and supervised learning (e.g., with only labelled training data).

Deep learning may refer to a class of machine learning algorithms that employ artificial neural networks (e.g., specifically deep neural networks (DNNs)) which were loosely inspired from biological systems. The Deep Neural Networks (DNNs) may be a special class of machine learning models inspired by human brain, where the input is linearly transformed and pass-through non-linear activation function one or more times. DNNs may include one or more layers, where each layer may include a linear transformation and/or a given non-linear activation functions. The DNNs can be trained using the training data via back-propagation algorithm. DNNs may show (e.g., state-of-the-art) performance in one or more domains (e.g., speech, vision, natural language, etc.) and/or for one or more machine learning settings (e.g., supervised, un-supervised, and/or semi-supervised). The term AI/ML based methods/processing may refer to realization of behaviours and/or conformance to requirements by learning based on data, without explicit configuration of sequence of steps of actions. Such methods may enable learning complex behaviours, which may be difficult to specify and/or implement when using other (e.g., legacy) methods.

A WTRU may transmit and/or receive a physical channel and/or reference signal according to at least one spatial domain filter. The term beam may be used to refer to a spatial domain filter.

The WTRU may transmit a physical channel and/or signal using the same spatial domain filter as the spatial domain filter used for receiving an RS (e.g., such as CSI-RS) and/or a synchronization signal (SS) block. The WTRU transmission may be referred to as target, and/or the received RS and/or SS block may be referred to as reference and/or source. In examples, the WTRU may transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and/or second transmissions may be referred to as target and/or reference (and/or source), respectively. In examples, the WTRU may transmit the first (e.g., target) physical channel and/or signal according to a spatial relation with a reference to the second (e.g., reference) physical channel and/or signal.

A spatial relation may be implicit, configured by radio resource control (RRC), and/or signalled by MAC CE and/or DCI. For example, a WTRU may (e.g., implicitly) transmit PUSCH and/or demodulation RS (DM-RS) of PUSCH according to the same spatial domain filter as a sounding reference signal (SRS) indicated by a SRS resource indicator (SRI) indicated in DCI and/or configured by RRC. In examples, a spatial relation may be configured by RRC for an SRS resource indicator (SRI) and/or signalled by MAC CE for a PUCCH. Such spatial relation may (e.g., also) be referred to as a beam indication.

The WTRU may receive a first (e.g., target) downlink channel and/or signal according to the same spatial domain filter and/or spatial reception parameter as a second (e.g., reference) downlink channel and/or signal. For example, such association may exist between a physical channel (e.g., such as physical downlink control channel (PDCCH) and/or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS and/or SS block and a DM-RS by an index to a set of TCI states configured by RRC and/or signalled by MAC CE. Such indication may (e.g., also) be referred to as a beam indication.

A transmission and reception point (TRP) may be interchangeably used with one or more of a transmission point (TP), reception point (RP), radio remote head (RRH), distributed antenna (DA), base station (BS), a sector (e.g., of a base station), and/or a cell (e.g., a geographical cell area served by a BS). Multi-TRP may be interchangeably used with one or more of MTRP, M-TRP, and/or multiple TRPs.

A WTRU may report a subset of CSI components. The CSI components may correspond to at least a CSI-RS resource indicator (CRI), a synchronization signal block (SSB) resource indicator (SSBRI), an indication of a panel used for reception at the WTRU (e.g., such as a panel identify and/or group identity), measurements such as layer 1 (L1)-reference signal received power (RSRP), L1-signal to interference plus noise (SINR) (L1-SINR) taken from SSB and/or CSI-RS (e.g. cri-RSRP, cri-SINR, ssb-Index-RSRP, ssb-Index-SINR), and/or other CSI such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), a secondary synchronization signal (SSS), and/or a physical broadcast channel (PBCH). The WTRU may monitor, receive, and/or attempt to decode an SSB during initial access, initial synchronization, radio link monitoring (RLM), cell search, cell switching, and/or the like.

A WTRU may measure and/or report the CSI. The CSI for each connection mode may include and/or be configured with one or more of the following. The CSI for each connection mode may include and/or be configured with CSI report configuration, which may include one or more of: CSI report quantity (e.g., CQI, RI, PMI, CRI, LI, etc.); CSI report type (e.g., aperiodic, semi-persistent, periodic); SI report codebook configuration (e.g., Type I, Type II, Type II port selection, etc.); and/or CSI report frequency. The CSI for each connection mode may include and/or be configured with a CSI-RS resource set. The CSI-RS resource set may include one or more of the following CSI resource settings: non-zero power (NZP)-CSI-RS resource for channel measurement, NZP-CSI-RS resource for interference measurement, and/or CSI-interference measurement (CSI-IM) resource for interference measurement. The CSI for each connection mode may include and/or be configured with NZP CSI-RS resources. NZP CSI-RS resources may include one or more of the following: NZP CSI-RS resource ID, periodicity and/or offset; quasi co-location (QCL) information and/or TCI-state; and/or resource mapping (e.g., number of ports, density, code division multiplexing (CDM) type, etc.).

A WTRU may indicate, determine, and/or be configured with one or more reference signals. The WTRU may monitor, receive, and/or measure one or more parameters based on the respective reference signals. For example, one or more of the following may apply. The following parameters may be non-limiting examples of the parameters that may be included in reference signal(s) measurements: SS-RSRP, SS-SINR, CSI-SINR, received signal strength indicator (RSSI), cross-layer interference (CLI)-RSSI, and/or SRS-RSRP. One or more of these parameters may be included. Other parameters may be included.

SS reference signal received power (SS-RSRP) may be measured based on the synchronization signals (e.g., demodulation reference signal (DMRS) in PBCH and/or SSS). SS-RSRP may be referred to as the linear average over the power contribution of the resource elements (RE) that carry the respective synchronization signal. In measuring the RSRP, power scaling for the reference signals may be required. In case SS-RSRP is used for L1-RSRP, for example, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH and/or SSS). SS-SINR may be referred to as the linear average over the power contribution of the resource elements (RE) that carry the respective synchronization signal divided by the linear average of the noise and interference power contribution. In case SS-SINR is used for L1-SINR, for example, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, for example, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and/or non-serving cells, adjacent channel interference, thermal noise, and/or the like).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and/or non-serving cells, adjacent channel interference, thermal noise, and/or the like).

Sounding reference signals RSRP (SRS-RSRP) may be measured based on the linear average over the power contribution of the resource elements (RE) that carry the respective SRS.

A CSI report configuration (e.g., CSI-ReportConfigs) may be associated with a single bandwidth part (BWP) (e.g., indicated by BWP-Id). One or more of the following parameters may be configured: CSI-RS resources and/or CSI-RS resource sets for channel and interference measurement; CSI-RS report configuration type including the periodic, semi-persistent, and/or aperiodic; CSI-RS transmission periodicity for periodic and/or semi-persistent CSI reports; CSI-RS transmission slot offset for periodic, semi-persistent, and/or aperiodic CSI reports; CSI-RS transmission slot offset list for semi-persistent and/or aperiodic CSI reports; one or more time restrictions for channel and/or interference measurements; report frequency band configuration (e.g., wideband/subband CQI, PMI, and/or the like); one or more thresholds and/or modes of calculations for the reporting quantities (e.g., CQI, RSRP, SINR, LI, RI, etc.); a codebook configuration; a group based beam reporting; a CQI table; a Subband size; a Non-PMI port indication; a Port Index; and/or the like.

A WTRU may be configured with a CSI-RS resource configuration. A CSI-RS resource set (e.g., NZP-CSI-RS-Resourceset) may include one or more of CSI-RS resources (e.g., NZP-CSI-RS-Resource and/or CSI-ResourceConfig). A WTRU may be configured with one or more of the following in a CSI-RS resource: CSI-RS periodicity and/or slot offset for periodic and/or semi-persistent CSI-RS resources; CSI-RS resource mapping to define the number of CSI-RS ports, density, CDM-type, OFDM symbol, and/or subcarrier occupancy; the bandwidth part to which the configured CSI-RS is allocated; and/or the reference to the TCI-state including the QCL source RS(s) and/or the corresponding QCL types(s).

One or more of the following configurations may be used for RS resource set. A WTRU may be configured with one or more RS resource sets. The RS resource set configuration may include one or more of the following: RS resource set ID; one or more RS resources for the RS resource set; a repetition (e.g., on, off); an aperiodic triggering offset (e.g., one of 0-6 slots); and/or TRS information (e.g., true or not).

One or more of the following configurations may be used for RS resource. A WTRU may be configured with one or more RS resources. The RS resource configuration may include one or more of the following: a RS resource ID; a resource mapping (e.g., REs in a physical resource block (PRB); a power control offset (e.g., one value of-8, . . . , 15); a power control offset with SS (e.g.,-3 dB, 0 dB, 3 dB, 6 dB); a scrambling ID; a periodicity and/or offset; and/or QCL information (e.g., based on a TCI state).

A property of a grant and/or assignment may include one or more of the following. A property of a grant and/or assignment may include a frequency allocation. A property of a grant and/or assignment may include an aspect of time allocation (e.g., duration). A property of a grant and/or assignment may include a priority. A property of a grant and/or assignment may include a modulation and coding scheme. A property of a grant and/or assignment may include a transport block size. A property of a grant and/or assignment may include a number of spatial layers. A property of a grant and/or assignment may include a number of transports blocks. A property of a grant and/or assignment may include a TCI state, CRI, and/or SRI. A property of a grant and/or assignment may include a number of repetitions. A property of a grant and/or assignment may include whether the repetition scheme is Type A or Type B. A property of a grant and/or assignment may include whether the grant is a configured grant Type 1, type 2, and/or a dynamic grant. A property of a grant and/or assignment may include whether the assignment is a dynamic assignment and/or a semi-persistent scheduling (configured) assignment. A property of a grant and/or assignment may include a configured grant index and/or a semi-persistent assignment index. A property of a grant and/or assignment may include a periodicity of a configured grant and/or assignment. A property of a grant and/or assignment may include a channel access priority class (CAPC). A property of a grant and/or assignment may include one or more (e.g., any) parameters) provided in a DCI, by MAC, by LTE positioning protocol (LPP), and/or by RRC for the scheduling the grant and/or assignment.

An indication by DCI may include one or more of the following. An indication by DCI may include an (e.g., explicit) indication by a DCI field and/or by radio network temporary identifier (RNTI) used to mask cyclical redundancy check (CRC) of the PDCCH. An indication by DCI may include an (e.g., implicit) indication by a property such as DCI format, DCI size, CORESET and/or search space, aggregation level, first resource element of the received DCI (e.g., index of the first control channel element), and/or where the mapping between the property and the value may be signaled by RRC and/or MAC.

The WTRU may indicate the number of supported simultaneous CSI calculations N_{CPU} with parameter simultaneousCSI-ReportsPerCC in a component carrier, and/or simultaneousCSI-ReportsAIICC across one or more (e.g., all) component carriers. If a WTRU supports N_{CPU} simultaneous CSI calculations, it may have N_{CPU} CSI processing units for processing CSI reports. If L CPUs are occupied for calculation of CSI reports in a given OFDM symbol, the WTRU may have N_{CPU}-L unoccupied CPUs. If N CSI reports start occupying their respective CPUs on the same OFDM symbol on which N_{CPU}-L CPUs are unoccupied, where each CSI report n=0, . . . , N−1 corresponds to

$${O}_{CPU}^{( n )} ,$$

the WTRU may not (e.g., be required to) update the N−M requested CSI reports with lowest priority, where 0≤M≤N may be the largest value such that

$${\sum }_{n = 0}^{M - 1} {O}_{CPU}^{( n )} \leq {N}_{CPU} - L holds .$$

For a CSI report with CSI-ReportConfig with higher layer parameter reportQuantity not set to none, the CPU(s) may be occupied for a number of OFDM symbols as follows. A periodic and/or semi-persistent CSI report (e.g., excluding an initial semi-persistent CSI report on PUSCH after the PDCCH triggering the report and/or a semi-persistent CSI report on PUSCH configured with the higher layer parameter codebookType set to typeII-Doppler-r18 and/or typeII-Doppler-PortSelection-r18) may occupy CPU(s) from the first symbol of the earliest one of each CSI-RS/CSI-IM/SSB resource, and/or each CSI-RS/CSI-IM resource associated with one or more (e.g., all) configured sub-configurations for periodic CSI report corresponding to a CSI-ReportConfig that includes a list of sub-configurations provided by csi-ReportSubConfigList, and/or each CSI-RS/CSI-IM resource associated with one or more (e.g., all) triggered sub-configurations for semi-persistent CSI report corresponding to a CSI-ReportConfig that includes a list of sub-configurations provided by csi-ReportSubConfigList, for channel or interference measurement, respective latest CSI-RS/CSI-IM/SSB occasion no later than the corresponding CSI reference resource, until the last symbol of the configured PUSCH/PUCCH carrying the report. An aperiodic CSI report may occupy CPU(s) from the first symbol after the PDCCH triggering the CSI report until the last symbol of the scheduled PUSCH carrying the report. When the PDCCH reception includes two PDCCH candidates from two respective search space sets for the purpose of determining the CPU occupation duration, for example, the PDCCH candidate that ends later in time may be used. For example, the WTRU may use the PDCCH candidate that ends later in time.

An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets for the purpose of determining the CPU occupation duration, the PDCCH candidate that ends later in time may be used. A semi-persistent CSI report on PUSCH configured with the higher layer parameter codebookType set to typeII-Doppler-r18 and/or typeII-Doppler-PortSelection-r18 may occupy CPU(s) from the first symbol of Kₚ-th latest consecutive periodic/semi-persistent CSI-RS occasions no later than CSI reference resource, until the last symbol of the PUSCH carrying the report, where the value of Kₚ ∈ {1,2,4} may be indicated by WTRU capability.

For a CSI report with CSI-ReportConfig with higher layer parameter reportQuantity set to none and CSI-RS-ResourceSet with higher layer parameter trs-Information not configured, the CPU(s) may be occupied for a number of OFDM symbols as follows. A semi-persistent CSI report (e.g., excluding an initial semi-persistent CSI report on PUSCH after the PDCCH triggering the report) may occupy CPU(s) from the first symbol of the earliest one of each transmission occasion of periodic and/or semi-persistent CSI-RS/SSB resource for channel measurement for L1-RSRP computation, until

$${Z}_{3}^{′}$$

symbols after the last symbol of the latest one of the CSI-RS/SSB resource for channel measurement for L1-RSRP computation in each transmission occasion. An aperiodic CSI report may occupy CPU(s) from the first symbol after the PDCCH triggering the CSI report until the last symbol between Z₃ symbols after the first symbol after the PDCCH triggering the CSI report and/or

$${Z}_{3}^{′}$$

symbols after the last symbol of the latest one of each CSI-RS/SSB resource for channel measurement for L1-RSRP computation.

TABLE 1
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X5 + KB3) | X5 |
| 6 | 776 | 680 | 1216 | 1120 | min(776, X6 + KB4) | X6 |

RS may be interchangeably used with one or more of RS resource, RS resource set, RS port, and/or RS port group. RS may be interchangeably used with one or more of SSB, CSI-RS, SRS, DM-RS, TRS, positioning RS (PRS), and/or phase tracking RS (PTRS). An RS may be used interchangeably herein with one or more of: SRS, CSI-RS, DM-RS, PT-RS, and/or SSB.

A channel may be used interchangeably herein with one or more of: PDCCH, PDSCH, physical uplink control channel (PUCCH), physical uplink shared channel (PUSCH), physical random access channel (PRACH), and/or the like.

A key performance indicator (KPI) may refer to one or more of the following. A KPI may refer to a signal quality (e.g., L1-RSRP, SINR, CQI, RSSI, reference signal received quality (RSRQ). A KPI may refer to a prediction performance. For example, a prediction performance may include a percentage of the top-1 genie-aided (e.g., strongest) beam may be one of the top-k predicted beams. A KPI may refer to a link quality (e.g., throughput, block error rate (BLER)). A KPI may refer to data distribution (e.g., mean and/or variance of measured and/or predicted beam measurements). A KPI may refer to RSRP (e.g., L1-RSRP) difference (e.g., the difference between measured and predicted RSRP of a beam.

A signal, channel, and/or message (e.g., as in DL and/or uplink (UL) signal, channel, and/or message) may be used interchangeably herein. A RS resource set may be used interchangeably herein with a RS resource and/or a beam group. Beam reporting may be used interchangeably herein with CSI measurement, CSI reporting, and/or beam measurement. Embodiments described herein with respect to beam resources prediction may be used for beam resources belonging to a single and/or one or more (e.g., multiple) cells, and/or single and/or one or more (e.g., multiple) TRPs. CSI reporting may be used interchangeably herein with CSI measurement, beam reporting, and/or beam measurement. A RS resource set may be used interchangeably herein with a beam group. Set B may be used interchangeably herein with a set of RS resource sets, beams, beam-pairs, beam RS resources, RS resources, and/or a beam pattern. Set B may be used interchangeably herein with measurement RS resources, measurement RS resource set, measurement beam resources, measurement beam resource set, measurement beam pattern, measurement TCI states, measurement TCI state group, and/or the like. Set A may be used interchangeably herein with a set of RS resource sets, beams, beam-pairs, beam RS resources, RS resources, and/or a beam pattern. Beam prediction accuracy may be used interchangeably herein with prediction accuracy.

A WTRU may include capability to communicate between the WTRU and the network about AI/ML capability at the WTRU. For example, a WTRU may indicate to the network the supported AI/ML model(s) and/or function(s), confidence level of prediction(s), time horizon of prediction(s) (e.g., how far along in the future are the prediction(s) being made) and/or the like.

A WTRU may support one or more AI/ML models for a certain functionality (e.g., with different prediction time horizons, prediction confidence levels, processing requirements, trained under/for operation in different frequencies/cells/location/times of day, etc.). A given AI/ML model can operate in different modes (e.g., with different levels of prediction confidence levels at different prediction time horizons, at different locations, frequencies, WTRU mobility pattern/speed, etc.).

The AI/ML model(s) can be available at the WTRU trained and/or the WTRU may receive an untrained AI/ML model(s) and train the AI/ML model(s). The AI/ML model(s) may be available at the WTRU trained, and/or the WTRU may be enabled and/or configured to perform (e.g., further) training (e.g., for different condition(s) such as frequencies/cells/location/times of day, for the same condition(s) as the initial training but for increasing the level of confidence and/or the prediction time horizon, for different WTRU speeds, etc.). The AI/ML model(s) may be available at the WTRU but not trained and/or (e.g., only) trained for certain WTRU/network conditions. The WTRU may be configured to train the AI/ML model(s) (e.g., for condition(s) that the AI/ML model(s) are not yet trained for).

In examples, the WTRU may require one or more configurations and/or inputs for performing the inference(s) using one or more AI/ML models. For example, for beam prediction, the WTRU may be configured with a certain number of beams to measure other beams (e.g., set A/B configuration as described herein). In examples, the WTRU may communicate the required configuration and/or input as part of the capability information. In examples, the required configuration and/or input may be communicated to the network based on a capability request (e.g., based on explicit network request, if the WTRU gets configured to perform AI/ML based on BM operations and/or it may have determined that the WTRU is lacking the required configuration and/or input(s), etc.).

AI/ML functionality may be associated with a set of KPIs and/or metrics. For example, KPIs and/or metrics associated with AI/ML functionality may include prediction accuracy, average and/or mean square difference between measured and predicted values, etc. For example, for the beam prediction, KPIs and/or metrics associated with AI/ML functionality may include the beam prediction accuracy and/or confidence level, L1-RSRP difference between the measured and predicted beam levels, etc. A WTRU may have one or more AI/ML models for a given functionality. Each AI/ML functionality may have performance levels that meet different KPI thresholds (e.g., WTRU may have two models where a first AI/ML model has an accuracy level of 90% and a second AI/ML model has an accuracy level of 95%, etc.). The WTRU may inform the network during its capability reporting and/or based on (e.g., after) the capability reporting.

An AI/ML model may be trained under certain WTRU and/or network side (e.g., additional) conditions. For example, a WTRU-side condition may be the speed of the WTRU. A network side (e.g., additional) condition may be a condition related to a network configuration and/or setting that the WTRU may not be aware of, but may impact the performance of the model. For example, an AI/ML beam management model may perform differently if the AI/ML beam management model is trained when the network was using a certain antenna pattern, beam pattern, power levels, and/or the like. Additionally or alternatively, one or more aspects related to a network load may impact the (e.g., AI/ML) model performance.

Since a WTRU may not know one or more (e.g., all) details of the network side (e.g., additional) condition(s) (e.g., and/or the network may also not want to expose one or more of these implementations), the network may hide these details by signaling to the WTRU one or more associated IDs. For example, when data is being collected for training a model, tagging may be performed indicating under which network side (e.g., additional) condition(s) the model is being trained. When a WTRU is being configured to perform an AI/ML operation, the WTRU may be configured to check the consistency between the condition(s) under which the AI/ML model is trained on and one or more current conditions (e.g., current WTRU conditions, current associated ID(s) signaled by the network indicating current network conditions and/or settings, etc.).

In examples, full and/or partial validity/applicability of an associated ID may refer to indicate whether the WTRU has an AI/ML model/functionality that is valid/applicable for the concerned associated ID (e.g., the network may signal the same associated ID(s) to one or more WTRUs, and/or a first WTRU may determine the associated ID to be fully applicable, a second WTRU may determine it to be partially applicable, and/or a third WTRU may determine it to be not applicable.

The term life cycle management (LCM) may be used to describe the (e.g., overall) management aspects of AI/ML models. Aspects of AI/ML model(s) may include one or more of: model training; functionality/model identification; model delivery/transfer; model inference operation; functionality/model selection, activation, deactivation, switching, and/or fallback operation; functionality/model monitoring; model update; WTRU capability; and/or data collection (e.g., for model training, for monitoring, for inference, etc.). Functionality/model selection, activation, deactivation, switching, and/or fallback operation may include a decision by the network (e.g., network initiated and/or WTRU-initiated and requested to the network), a decision by the WTRU (e.g., event-triggered as configured by the network, WTRU's decision reported to the network, and/or a WTRU-autonomous with WTRU's decision reported to the network and/or without it). For example, a decision by the WTRU may be an autonomous WTRU decision.

LCM can be functionality-based LCM and/or model-ID based LCM.

In functionality-based LCM, a network may indicate activation/deactivation/fallback/switching of AI/ML functionality via (e.g., 3GPP) signaling (e.g., RRC, MAC-CE, DCI). One or more models may not be identified at the network, and/or the WTRU may perform model-level LCM. A WTRU may have one AI/ML model for the functionality, and/or the WTRU may have one or more (e.g., multiple) AI/ML models for the functionality. In the functionality-based LCM, the WTRU may choose the AI/ML model(s) to use for a certain functionality (e.g., network decides for which functionalities the WTRU can use AI/ML based operation, and/or the WTRU may choose the AI/ML(s) model to use).

In model-ID based LCM, one or more models may be identified at the network, and/or the Network and/or WTRU may activate/deactivate/select/switch individual AI/ML models via model ID. In the model-ID based LCM, the network may (e.g., explicitly) control which particular model is used for a given AI/ML functionality. For example, the WTRU may send details of AI/ML model(s) and/or their capabilities; a network may determine which model to activate for a particular functionality.

Embodiments described herein may be applicable to (e.g., both) model-ID based and/or functionality-based LCM. Embodiments described herein may relate to how the WTRU determines whether it has a (e.g., AI/ML) model that is applicable for the indicated associated ID(s). For example, in the case of functionality-based LCM, the WTRU may be configured and/or requested to determine if a given functionality is valid/applicable, and/or the WTRU may perform the determination among one or more (e.g., all) of the models it has for a given functionality. The WTRU may consider the functionality applicable if at least one of the models is applicable. In examples, in the case of model-ID based LCM, the WTRU may be configured/requested by the network to determine whether a particular (e.g., AI/ML) model is applicable.

The activation of an associated ID may refer to a network configuring the WTRU with an associated ID to use and/or consider and/or (e.g., further) indicating to the WTRU to determine if the WTRU has an AI/ML model and/or functionality that is applicable for that associated ID (and/or sub-associated IDs).

In examples, the applicability of an associated ID may refer to the WTRU having an I/ML functionality and/or (e.g., AI/ML) model that is applicable for the concerned associated ID (and/or related sub-associated IDs).

In the case of functionality-based LCM, for example, the WTRU may consider the associated ID applicable (and/or partially applicable) if there is at least one AI/ML model for that functionality that meets the applicability (and/or partially applicability) criteria, as described herein.

In the case of model-ID based LCM, for example, the WTRU may determine the associated ID's applicability (and/or partial applicability) for each AI/ML model for that functionality and/or the WTRU may be (e.g., explicitly) configured to determine a certain sub set of the AI/ML models. The WTRU may report the non-applicability, partial applicability, and/or (e.g., full) applicability for one or more (e.g., all) the models (and/or the configured sub set of models). For example, the WTRU may send a list of the applicable model(s), a list of the non-applicable model(s), a list of the partially applicable model(s), etc., and/or a bitmap indicating which model(s) are (e.g., partially) applicable and/or non-applicable, where the order in the bitmap is, for example, based on a model ID sorting order agreed upon the WTRU and the network, etc.).

An associated ID may be unique for a certain functionality and/or it may be shared among one or more functionalities. For the case where an associated ID can be applicable for more than one functionality, the WTRU may determine applicability for the associated ID for each of the concerned functionality(ies) according to one or more of the embodiments described herein. The WTRU may indicate to the network to which of the functionality(ies) the associated ID is applicable or not (e.g., a list of applicable functionalities, a list of non-applicable functionalities, a list of partially applicable functionalities, etc., and/or using a bitmap structure (e.g., as described herein, similar to the bitmap structure for the model ID based LCM, etc.).

In examples, the WTRU may be configured to start applying the AI/ML model and/or functionality if the WTRU determines the AI/ML model and/or functionality to be applicable for the configured and/or indicated associated ID. In examples, the WTRU may indicate the applicability to the network and/or may wait for an indication from the network to activate the AI/ML functionality and/or model.

In examples, the WTRU may be configured with a time duration. The WTRU may activate the concerned (e.g., AI/ML) functionality and/or model based on the configured time duration. For example, if the WTRU does not receive an indication from the network to not activate the concerned functionality and/or (e.g., AI/ML) model (e.g., within the time duration after the reception of the associated ID activation command, within the time duration after the sending of the applicability and/or partial applicability indication, within the time duration after the reception of a lower layer acknowledgement (ACK) indicating the reception of the application indication by the network, etc.), the WTRU may activate the concerned (e.g., AI/ML) functionality and/or model.

The one or more AI/ML functionalities described herein (e.g., beam management) may be a non-limiting list of examples. Other AI/ML functionalities may be associated with the embodiments described herein. For example, embodiments may be used for one or more AI/ML functionalities if the functionality is to be used in a multi-TRP scenario; the functionality may be impacted based on whether the WTRU operates in a single TRP and/or multi-TRP scenario. Embodiments described herein may be valid to one or more other forms of functionality that use prediction that is not based on AI/ML (e.g., time series forecasting, interpolation methods, etc.).

One or more (e.g., all of) the embodiments described herein may be agnostic to the kind of AI/ML model/technique(s) used by the WTRU. For example, one or more of the following may be agnostic to the kind of AI/ML model/technique(s) used by the WTRU: the algorithm used; the mechanism such as neural network and/or what kind of neural network (e.g., depth and/or parameters/weights of the network, etc.,); the origin(s) of the model (e.g., WTRU vendor, operator, network vendor, etc.,); and/or how and/or where the training of the model may be done (e.g., the input data used for the training, where the training is performed, if the training is performed offline or online, etc.,). The model may be trained on historical observation of one or more WTRUs' actual measurements in different WTRU and/or network conditions. For example, the model may be trained during certain time durations of the day, during certain days of the week, at different locations, different WTRU mobility patterns and/or speeds, under different network conditions that are visible to the WTRU (e.g., frequency and/or bandwidth, etc.), under different network configurations, which may be visible to the WTRU just as a network configuration index that is provided by the network at the time of training or data collection for the training, etc.,).

Sub-associated IDs may be described herein. Sub-associated IDs may not be limited to one level of grouping. An associated ID may include a group of sub-associated IDs. For example, embodiment(s) can include a sub-associated ID having one or more related sub-associated ID(s) of its own (e.g., one or more layers of grouping of associated IDs). Additionally or alternatively, a sub-associated ID may belong to more than one associated ID. The terms functionality and procedure may be used interchangeable herein.

Embodiments described herein may include monitoring RS resource set activation and/or performance monitoring procedure based on prediction(s) and/or measurement(s).

A WTRU may receive one or more of the following configurations.

The WTRU may receive one or more TCI states (e.g., based on a list of TCI states).

The WTRU may receive one or more first type CSI report configurations. Each first type CSI report configuration may include at least one or more of the following parameters. Each first type CSI report configuration may include one or more CSI resource configurations. A first CSI resource configuration may be associated with a RS resource Set for Set A and/or a second CSI resource configuration may be associated with a RS resource set for set B. Each first type CSI report configuration may include a CSI report quantity (e.g., channel quality indicator (CQI), rank indicator (RI), precoding matrix indicator (PMI), CSI-RS resource indicator (RI), layer indicator (LI), etc.). Each first type CSI report configuration may include a CSI report type (e.g., aperiodic, semi-persistent, periodic). Each first type CSI report configuration may include a CSI report codebook configuration (e.g., Type I, Type II, Type II port selection, etc.). Each first type CSI report configuration may include a CSI report frequency. Each first type CSI report configuration may include one or associated IDs.

The WTRU may receive one or more second type CSI report configurations. Each second type CSI report configuration may include at least one or more of the following parameters. Each second type CSI report configuration may include one or more CSI resource configurations. A CSI resource configuration may be associated with one or more RS resource sets for monitoring. Each CSI resource configuration may be associated with each monitoring RS resource set. For example, a first CSI resource configuration may be associated with a RS resource set for monitoring and/or a second CSI resource configuration may be associated with a RS resource set for monitoring. Each monitoring RS resource set may be associated with a group of TCI states among the one or more configured TCI states. Each second type CSI report configuration may include one or more first CSI report configuration IDs (e.g., for inference) associated with each second type CSI report configuration. Each second type CSI report configuration may include a CSI report quantity (e.g., beam accuracy indicator (BAI). Each second type CSI report configuration may include a CSI report type (e.g., WTRU triggered, aperiodic, semi-persistent, periodic). A beam prediction quality threshold may be configured, for example, if the transmission type is WTRU triggered. Each second type CSI report configuration may include a CSI report frequency. Each second type CSI report configuration may include one or more associated IDs.

In examples, the WTRU may receive an indication of one or more TCI states. For example, one or more of the following may be used. The WTRU may receive DCI based TCI state indication (e.g., unified TCI state and/or PDSCH). For example, the WTRU may receive an indication of one or more TCI states among the one or more configured TCI states via DCI. The WTRU may apply the TCI state for one or more of receiving PDCCH, receiving PDSCH, transmitting PUCCH, transmitting PUSCH, etc. The WTRU may receive MAC CE based TCI state indication (e.g., PDCCH and/or PUCCH). For example, the WTRU may receive an indication of one or more TCI states among the one or more configured TCI states via MAC CE. The WTRU may apply the TCI state for receiving PDCCH and/or transmitting PUCCH and/or the like. The indication may indicate the one or more TCI states per CORESET/search space and/or PUCCH resource. The WTRU may receive RRC based TCI state indication. For example, the WTRU may receive a configuration of one or more TCI states via RRC. The WTRU may apply the TCI state for one or more of receiving PDCCH, receiving PDSCH, transmitting PUCCH, transmitting PUSCH, and/or the like.

In examples, the WTRU may activate one or more RS resource sets for monitoring. The WTRU may activate one or more RS resource sets for monitoring based on one or more of the following. The WTRU may activate one or more RS resource sets for monitoring based on one or more activated and/or indicated TCI states. For example, the WTRU may activate one or more RS resource sets associated with the activated and/or indicated TCI states. The WTRU may activate one or more RS resource sets for monitoring based on WTRU reported RS(s). For example, the WTRU may activate one or more RS resource sets associated with indicated and/or reported RSs (e.g., via CRIs and/or SSBRIs). For example, the WTRU may activate a RS resource set which includes the indicated and/or reported RS(s). The WTRU may determine a RS resource set of one or more RS resource sets, for example, if the WTRU indicates the one or more RS resource sets. For example, the WTRU may use a RS resource set with a reported strongest beam (e.g., via firstly reported CRI/SSBRI) and/or a RS resource set that includes a larger number of reported beams than other RS resource set(s).

The WTRU may activate one or more RS resource sets for monitoring based on a gNB indication. For example, the WTRU may receive an indication for activating one or more RS resource sets for monitoring. The indication may indicate CSI report configuration ID associated with the activation.

The WTRU may activate one or more RS resource sets for monitoring based on a blind detection. For example, the WTRU may blindly detect RS resource set(s) for monitoring. For example, the WTRU may detect RS resource set(s) for monitoring based on a sequence of CSI-RS/SSB. The WTRU may use blind detection (e.g., only) when the WTRU does not receive a confirmation of WTRU reporting (e.g., for performance monitoring).

In examples, the WTRU may initiate and/or reset a performance evaluation counter. For example, one or more of the following events may be used for initiating and/or resetting the performance evaluation counter.

The WTRU may initiate and/or reset the performance evaluation counter based on RRC (re) configuration (e.g., of CSI report configuration(s)). For example, the WTRU may initiate and/or reset the performance evaluation counter when the WTRU receives RRC configuration and/or reconfiguration (e.g., of CSI report configuration(s) for performance monitoring).

The WTRU may initiate and/or reset the performance evaluation counter based on (e.g., new) reporting information. For example, the WTRU may initiate and/or reset the performance evaluation counter when the WTRU indicates and/or reports (e.g., new) reporting information (e.g., based on a first type CSI report configuration and/or a second type CSI report configuration). The (e.g., new) reporting information may include one or more of the following. The (e.g., new) reporting information may include an indication that indicates other (e.g., new) beams (e.g., different CRIs/SSBRIs than the previous inference report). The (e.g., new) reporting information may include an indication that indicates other (e.g., new) PMIs (e.g., different PMIs than the previous inference report). The (e.g., new) reporting information may include an indication that indicates other (e.g., new) RIs (e.g., different RIs than the previous inference report). The (e.g., new) reporting information may include an indication that indicates other (e.g., new) LIs (e.g., different LIs than the previous inference report).

The WTRU may initiate and/or reset the performance evaluation counter based on (e.g., newly) activated CSI report configuration. For example, the WTRU may receive an indication of activation for the second type CSI report configuration (e.g., for performance monitoring). The WTRU may initiate and/or reset the performance evaluation counter associated with the (e.g., newly) activation second type CSI report configuration. For example, the WTRU may receive an indication of activation for the first type CSI report configuration associated with the second type CSI report configuration. The WTRU may initiate and/or reset the performance evaluation counter associated with the (e.g., newly) activation second type CSI report configuration.

The WTRU may initiate and/or reset the performance evaluation counter based on (e.g., newly) activated RS resource set. For example, the WTRU may receive an indication of activation for monitoring RS resource sets (e.g., for performance monitoring) associated with the second type CSI report configuration. The WTRU may initiate and/or reset the performance evaluation counter associated with the (e.g., newly) activation second type CSI report configuration. For example, the WTRU may receive an indication of activation for the RS resource set(s) (e.g., for Set A and/or for set B) associated with the first type CSI report configuration associated with the second type CSI report configuration. The WTRU may initiate and/or reset the performance evaluation counter associated with the (e.g., newly) activation second type CSI report configuration.

In examples, the WTRU may increase the performance evaluation counter based on one or more of the following.

The WTRU may increase the performance evaluation counter based on one or more measurements for inference. For example, the WTRU may increase the performance evaluation counter when the WTRU measures one or more RS resource sets associated with a first type CSI report configuration (e.g., for Set A and/or for set B). The WTRU may increase the performance evaluation counter when the WTRU starts measuring the one or more RS resource sets (e.g., a first symbol of the one or more RS resource sets). The WTRU may increase the performance evaluation counter when the WTRU finishes measuring the one or more RS resource sets (e.g., based on measuring a last symbol of the one or more RS resource sets).

The WTRU may increase the performance evaluation counter based on an inference reporting instance. For example, the WTRU may increase the performance evaluation counter when the WTRU reports inference information based on a first type of CSI report configuration.

The WTRU may increase the performance evaluation counter based on one or more measurements for performance monitoring. For example, the WTRU may increase the performance evaluation counter when the WTRU measures one or more resource sets associated with a second type of CSI report configuration (e.g., for performance monitoring). The WTRU may increase the performance evaluation counter when the WTRU starts measuring the one or more RS resource sets (e.g., a first symbol of the one or more RS resource sets). The WTRU may increase the performance evaluation counter when the WTRU finishes measuring the one or more RS resource sets (e.g., based on measuring a last symbol of the one or more RS resource sets).

The WTRU may increase the performance evaluation counter based on a performance monitoring result reporting instance. For example, the WTRU may increase the performance evaluation counter according to the CSI reporting instance based on a second type CSI report configuration. In examples, the WTRU may not report the performance evaluation result(s) if the performance evaluation counter is not above the performance evaluation threshold.

In examples, the WTRU may evaluate performance of the inference based on inference result(s) and/or reported information based on a first type CSI report configuration. The WTRU may evaluate performance of the inference for each measurement instance (e.g., for one transmission of one or more RS resource sets) and/or for each reporting instance (e.g., based on a second type CSI report configuration). The WTRU may evaluate performance of the inference based on one or more of the following.

The WTRU may evaluate performance of the inference based on a first option (Top-1/1). The WTRU may determine the inference is accurate if the Top-1 beam with largest measured value of the resource set(s) for monitoring is Top-1 predicted beam. If satisfied, accuracy of A1 (e.g., 1) may be used.

The WTRU may evaluate performance of the inference based on a second option (1/Top-K). The WTRU may determine the inference is accurate if the Top-1 beam with largest measured value of L1-RSRP of the resource set(s) for monitoring is one of the Top-K predicted beams. If satisfied, accuracy of A2 (e.g., 1) may be used.

The WTRU may evaluate performance of the inference based on a third option (Top-K/M). The WTRU may determine the inference is accurate if the Top-K predicted beams are among Top M beam(s) with largest M measured value(s) of L1-RSRP(s) of the resource set(s) for monitoring. The WTRU may determine different evaluation performance based on the number of Top-K predicted beams, which may be among Top M beams. For example, accuracy of K/M and/or M/K may be used. In examples, predefined accuracy may be used based on a number of accurately predicted beams. For example, if (e.g., only) one beam is among the Top M beams, accuracy of A3 (e.g., ¼) may be used. For example, if two beam are among the Top M beams, accuracy of A4 (e.g., ½) may be used. For example, if one or more (e.g., all) beams are among the Top M beams, accuracy of A5 (e.g., fully accurate, 1) may be used. For example, the configuration information may indicate a plurality of strong beams. The beam prediction accuracy may include a third accuracy, a fourth accuracy, and/or a fifth accuracy When the performance evaluation counter is greater than threshold and the set of RS resources includes a RS resource indicated by the one or more sets of inference information, for example, the WTRU may predict at least one predicted beam based on the predicted measurement(s). The third, fourth, and/or fifth accuracy may be determined based on the plurality of strong beams and/or the at least one predicted beam.

The WTRU may evaluate performance of the inference based on a fourth option (strongest of Top-K/1 with margin). The WTRU may determine the inference is accurate if the beam with largest measured value of L1-RSRP of Top-K predicted beams is within a margin X dB of largest measured value of L1-RSRP of the resource set(s) for monitoring. When the performance evaluation counter is greater than threshold and the (e.g., second) set of RS resources includes a RS resource indicated by the first CSI report configuration (e.g., one or more sets of inference information), for example, the WTRU may predict at least one predicted beam based on the predicted measurements. The beam prediction accuracy may be determined based on a determination that a beam comprised in the at least one predicted beam comprises a highest layer one (L1)-reference signal received power (RSRP) value among the L1-RSRP values associated with the at least one predicted beam. The highest L1-RSRP value may be within a tolerance of a highest L1-RSRP value associated with the set of RS resources.

The WTRU may evaluate performance of the inference based on a fifth option (without strongest beam). The WTRU may determine the inference is accurate if measured L1-RSRP(s) may be within X dB margin from predicted RSRP(s) of the monitoring RS resource set. Measured L1-RSRP(s) may be from one or more beams with largest/average/median/minimum measured L1-RSRP(s) from one or more RS resource sets for monitoring. Measured L1-RSRP(s) may be from closest beam(s) with Top-K predicted beams (e.g., based on RS resource index (e.g., within a same RS resource set, for example, for monitoring and/or Set A). Predicted RSRP(s) may be from one or more beams with largest/average/median/minimum measured predicted RSRP(s) from one or more RS resource sets for inference (e.g., Set A and/or Set B). Predicted RSRP(s) may be from closest beam(s) with Top-L measured beams (e.g., based on RS resource index, for example, within a same RS resource set). For example, the same RS resource set may be for monitoring and/or Set A. In examples, different accuracy level may be used. For example, accuracy of A4 (e.g., ½) may be used. The performed actual measurements may include actual layer-one (L1) reference signal received power (RSRP) measurements. The predicted measurements may include predicted L1-RSRP measurements. The WTRU being configured to determine the beam prediction accuracy may include the WTRU being configured to determine whether each actual L1-RSRP measurement is within a tolerance of each predicted L1-RSRP measurement for each reporting and/or measurement instance of the at least one reporting and/or measurement instance when the performance evaluation counter is greater than threshold and the set of RS resources fails to comprise a RS resource indicated by the one or more sets of inference information.

In examples, the WTRU may determine (e.g., final) accuracy of prediction. For example, the WTRU may use one or more of the following to determine (e.g., final) accuracy of prediction. The WTRU may use a sum of accuracy for one or more (e.g., all, valid) measurement instances divided by a number of total (e.g., valid) measurements instances. The WTRU may use a sum of accuracy for one or more (e.g., all, valid) reporting instances divided by a number of total (e.g., valid) reporting instances.

In examples, a number of total (e.g., valid) reporting and/or measurement instances may be limited. For example, a maximum number of total (e.g., valid) reporting and/or measurement instances may be predefined and/or indicated (e.g., by a gNB, via one or more of RRC, MAC CE, and/or DCI).

In examples, a WTRU may determine performance evaluation and/or reporting method(s) based on one or more of the following.

The WTRU may determine performance evaluation and/or reporting method(s) based on whether activated one or more RS resource sets include predicted Top-K beams based on a first type CSI report configuration. The WTRU may determine whether reporting and/or measurement instance is valid (or not) based on whether activated one or more RS resource sets include predicted Top-K beams from WTRU reporting based on a first type CSI report configuration. For example, if the activated one or more RS resource sets include predicted Top-K beams, the WTRU may consider the reporting instance and/or measurement instance as valid. Otherwise, the WTRU may consider the reporting instance and/or measurement instance as invalid. Based on the determination, the WTRU may use accuracy of prediction (e.g., only) for valid reporting instances and/or measurement instances.

The WTRU may determine performance evaluation and/or reporting method(s) based on whether activated one or more RS resource sets include predicted Top-K beams from WTRU reporting based on a first type CSI report configuration. The determination may be based on (e.g., both) first type CSI-report configuration and/or second type CSI report configuration as (e.g., both) predicted Top-K beams (e.g., indicated RS resources according to inference result) and/or activated RS resource set(s) for monitoring may be used. For example, if the activated one or more RS resource sets include predicted Top-K beams, the WTRU may use a first method (e.g., one or more of options one through four, as described herein) for determining prediction accuracy. Otherwise, the WTRU may use a second method (e.g., Option 5). Each option may be (pre) defined and/or indicated and/or configured (e.g., by gNB).

The determination may be different based on one or more of a type of AI/ML model (e.g., with or without predicted RSRP), a report quantity of the first type CSI report configuration, and/or WTRU capability(ies). For example, if the AI/ML model, the report quantity of the first type CSI report configuration, and/or the WTRU capabilities support predicted RSRP, the WTRU may use the second method. Otherwise, the WTRU may consider invalid reporting instance(s) and/or measurement instance(s).

In examples, the WTRU may determine whether to evaluate and/or report performance evaluation result(s). For example, the WTRU may use one or more of the following methods to determine whether to evaluate and/or report performance evaluation result(s).

The WTRU may determine whether to evaluate and/or report performance evaluation result(s) based on a performance evaluation counter. For example, if the performance evaluation counter is above a performance evaluation threshold (e.g., indicated via one or more of RRC, MAC CE, and/or DCI), the WTRU may evaluate and/or report performance evaluation result(s). Otherwise, the WTRU may not evaluate and/or report performance evaluation result(s).

The WTRU may determine whether to evaluate and/or report performance evaluation result(s) based on a measured and/or predicted beam quality detection. For example, if a measured and/or predicted beam quality is lower than a threshold, the WTRU may evaluate and/or report performance evaluation result(s). The WTRU may apply a timer and/or a counter for monitoring measured and/or predicted beam quality to determine the evaluation and/or reporting. For example, if a number of detected events (e.g., the measured and/or predicted beam quality is lower than a quality threshold) is greater than an event threshold, the WTRU may trigger the WTRU reporting. The thresholds may be indicated via one or more of RRC, MAC CE, and/or DCI.

The WTRU may determine whether to evaluate and/or report performance evaluation result(s) based on whether activated one or more RS resource sets include predicted Top-K beams based on a first type CSI report configuration. The WTRU may determine whether to indicate performance evaluation result(s) (or not) based on whether activated one or more RS resource sets include predicted Top-K beams from WTRU reporting based on a first type CSI report configuration. For example, if activated one or more RS resource sets include predicted Top-K beams from WTRU reporting based on a first type CSI report configuration, the WTRU may perform evaluation and/or reporting based on a second type CSI report configuration. Otherwise, the WTRU may not perform the evaluation and/or reporting. For example, if top-K beam is included in monitoring RS resource set, the WTRU may report performance monitoring result(s). Otherwise, the WTRU may not report performance monitoring result(s).

In examples, the WTRU may report performance evaluation result(s) (e.g., based on a second type CSI report configuration). The performance evaluation result(s) may be based on one or more of the following: a number of accurate reporting instance(s) which satisfy (e.g., conditions association with option one, option 2, option 3, option 4, and/or option 5) the determined performance evaluation method(s) (e.g., BAI); a number of accurate measurement instance(s) which satisfy the determined performance method(s) (e.g., BAI); one or more determined accuracy(ies) (E.g., final accuracy) based on valid measurement and/or reporting instance(s) (e.g., as BAI); and/or beam information (e.g., one or more CRIs/SSBRIs and/or measured L1-RSRP(s) from the monitoring RS resource set(s)).

In examples, the WTRU may determine performance evaluation result(s). The WTRU may determine performance evaluation result(s) based on one or more of the following. The WTRU may determine performance evaluation result(s) based on whether activated one or more RS resource set(s) include predicted Top-K beams based on a first type CSI report configuration. For example, beam(s) may be indicated via CSI reporting based on the first type of CSI report configuration. The WTRU may determine performance evaluation result(s) based on an applied performance evaluation method. The WTRU may determine performance evaluation result(s) based on a number of valid measurement and/or reporting instances. The WTRU may determine performance evaluation result(s) based on one or more of a type of AI/ML model (e.g., with and/or without predicted RSRP, a report quantity of the first type CSI report configuration and/or WTRU capability(ies).

For example, if the activated one or more RS resource sets include predicted Top-K beams based on a first type CSI report configuration, the WTRU may indicate one or more of the following based on the first evaluation method (e.g., option(s) one through four as described herein). The WTRU may indicate a number of accurate reporting instances which satisfy the determined performance evaluation method(s). The WTRU may indicate a number of accurate measurement instances which satisfy the determined performance evaluation method(s). The WTRU may indicate one or more determined accuracies (e.g., final accuracy) based on valid measurement and/or reporting instance(s).

A WTRU may activate monitoring RS resource set based on an indicated TCI state and/or may perform prediction accuracy evaluation of inference CSI report configuration based on one or more strongest beams from the inference CSI report and/or activated monitoring RS resource set.

A WTRU may receive configuration information. For example, WTRU may receive configuration information to determine beam prediction accuracy associated with an artificial intelligence or machine learning (AI/ML) model at the WTRU. The configuration information may include an indication associated with at least one transmission configuration indication (TCI) state, a first channel state information (CSI) report configuration associated with a first set of reference signal (RS) resources to predict measurements, and/or a second CSI report configuration associated with monitoring a second set of RS resources. The configuration may include one or more (e.g., two or more) TCI states. The configuration information may include one or more (e.g., two or more) CSI reporting configurations. A first CSI reporting configuration may include at least one or more of the following parameters: a RS resource set for set A; a RS resource set for set B; ReportQuantity; and/or a transmission type (e.g., periodic, semi-static, and/or aperiodic). For example, the first CSI report configuration may indicate one or more RS resources (e.g., as a result of inference). A second CSI reporting configuration may include at least one or more of the following parameters for monitoring. For example, the second CSI report configuration can indicate a number of RS resource sets. For example, in high speed case, beam change can be faster than lower speed case; the number of candidates may (e.g., want to) be extended. This may be dynamically determined by the WTRU; the gNB may not have information. To decode the information (e.g., selected candidates), the gNB may know how many resource sets are used (e.g., first). A second CSI reporting configuration may include one or more monitoring RS resource sets. Each monitoring RS resource set may be associated with a group of TCI states. For example, a plurality of RS resource sets may include the second set of RS resources. The WTRU may select the second set of RS resources from the plurality of RS resource sets to activate the second set of RS resources to monitor. The second set of RS resources may be associated with the indication associated with the at least one TCI state. A second CSI reporting configuration may include a ReportQuantity. A second CSI reporting configuration may include a transmission type (e.g., WTRU triggered, periodic, semi-static, and/or aperiodic). A beam prediction quality threshold may be configured, for example, if the transmission type is WTRU triggered.

The WTRU may receive an indication of a TCI state for transmission and/or reception (e.g., one or more of physical downlink control channel (PDCCH), physical downlink shared channel (PDSCH), physical uplink control channel (PUCCH), and/or physical uplink shared channel (PUSCH). For example, the indication may indicate the TCI state to be applied for PDCCH, PDSCH, PUSCH, and/or PUCCH.

The WTRU may activate a monitoring RS resource set associated with the indicated TCI state. For example, the WTRU may activate the second set of RS resources to monitor, for example, based at least on the indication of the at least one TCI state. For example, one or more mechanism(s) may be used to activate a RS resource set for semi-persistent CSI-RS. When the RS resource set is deactivated, for example, the RS resource set may not be transmitted/used. Based on the activation (e.g., by receiving MAC CE), the RS resource set may be activated and/or received by the WTRU. Embodiments described herein may include tying the activation process with a strongest beam (e.g., the indicated TCI state) to reduce redundant procedure, for example, instead of (e.g., explicitly, separately) activating the RS resource set.

The WTRU may initiate a performance evaluation counter (e.g., 0). For example, the WTRU may start a performance evaluation counter to determine the beam prediction accuracy. The performance evaluation counter may be started and/or restarted based on one or more of a radio resource configuration, reporting information, an activated CSI report configuration, and/or an activated RS resource set. The performance evaluation counter may be a count on the number of inference instances that have been reported. Once the WTRU reports a number of inference instances above the threshold, for example, the WTRU may predict accuracy evaluation results (e.g., as described herein).

The WTRU may indicate one or more sets of inference information based on the first CSI reporting configuration. The WTRU may increase the performance evaluation counter when the WTRU indicates the one or more sets of inference information. For example, a WTRU may send a CSI report configuration to the network with the inferred and/or predicted CSI based on the first CSI report configuration.

In accordance with the first CSI report configuration, the WTRU may predict measurements for at least one reporting and/or measurement instance.

If the performance evaluation counter exceeds a performance evaluation counter threshold, for example, the WTRU may report prediction accuracy evaluation results (e.g., WTRU triggered) based on the one or more sets of inference information.

If the monitoring RS resource set (and/or the RS resource set for set B) (e.g., activated RS resource set among the configured resource set(s) by the second CSI report configuration) includes a RS resource indicated by the first CSI report configuration (e.g., one or more sets of inference information), for example, the WTRU may perform evaluation based on one or more of the following. The WTRU may perform evaluation based on a first option (Top-1/1). The Top-1 beam(s) with the largest measured value of the resource set(s) for monitoring may be Top-1 predicted beam(s). When the performance evaluation counter is greater than threshold and the (e.g., second) set of RS resources includes a RS resource indicated by the first CSI report configuration (e.g., one or more sets of inference information), for example, the WTRU may predict a strongest beam based on the predicted measurements. The beam prediction accuracy may include a first accuracy. The first accuracy may be determined when a beam with a highest measured value of the RS resource set is the strongest beam. The WTRU may perform evaluation based on a second option (1/Top-K). The Top-1 beam with the largest measured value of L1-RSRP of the resource set(s) for monitoring may be one of the Top-K predicted beams. When the performance evaluation counter is greater than threshold and the (e.g., second) set of RS resources include a RS resource indicated by the first CSI report configuration (e.g., one or more sets of inference information), for example, the WTRU may predict at least one predicted beam based on the predicted measurements. The beam prediction accuracy may include a second accuracy. The second accuracy may be determined when the at least one predicted beam includes a beam with highest measured value of layer one (L1)-reference signal received power (RSRP). The WTRU may perform evaluation based on a third option (Top-K/M). The Top-K predicted beams may be among Top M beam(s) with largest M measured value(s) of L1-RSRP(s) of the resource set(s) for monitoring. The WTRU may determine different evaluation performance based on the number of Top-K predicted beams, which may be among Top M beams. K and M may be different. In examples, K can be 5 and M can be 10. In examples, if one beam is among Top M beams, the accurate inference may be ¼ accurate. For example, if two beams are among Top M beams, the accurate inference may be ½ accurate. For example, if one or more (e.g., all) beams are among Top M beams, the accurate inference may be completely accurate (e.g., 4/4 accurate). The WTRU may perform evaluation based on a fourth option (strongest of Top-K/1 with margin). The beam with the largest measured value of L1-RSRP of Top-K predicted beams may be within a margin of X dB of largest measured value of L1-RSRP of the resource set(s) for monitoring.

If the monitoring RS resource set (and/or the RS resource set for Set B) (e.g., activated RS resource set among the configured resource set(s) by the second CSI report configuration) does not include the RS resource indicated by the first CSI report Configuration (e.g., one or more sets of inference information), for example, the WTRU may perform evaluation based on one or more of the following. The WTRU may perform evaluation based on measured L1-RSRP(s) within X dB margin from prediction RSRP(s) of the monitoring RS resource set. For example, measured L1-RSRP(S) and/or predicted RSRP(s) may be from largest and/or minimum measurement and/or prediction beam and/or average of one or more (e.g., all) beams. If satisfied (e.g., based on measured L1-RSRP(s) within X dB margin from prediction RSRP(s) of the monitoring RS resource set), the accurate information may be ½ accurate.

The WTRU may determine prediction accuracy of the first CSI report configuration based on, for example, the determined accuracy (e.g., for each instance). For example, the WTRU may determine prediction accuracy of the first CSI report configuration based on a sum of inference accuracy divided by the number of inference reporting instances. The WTRU may determine the beam prediction accuracy based on the configuration information, the performance evaluation counter, the first set of RS resources, and/or the second set of RS resources. The beam prediction accuracy may represent a ratio of correctly predicted measurements to performed actual measurements for each reporting or measurement instance of the at least one reporting and/or measurement instance.

The WTRU may indicate the determine evaluated prediction accuracy (e.g., to a gNB) based on the second CSI reporting configuration. For example, the WTRU may send an indication of the beam prediction accuracy based at least on the second CSI report configuration and/or the performance evaluation counter. The WTRU being configured to send the indication of the beam prediction accuracy may include the WTRU being configured to send an indication of the ration of correctly predicted measurements to performed actual measurements for each reporting and/or measurement instance of the at least one reporting and/or measurement instance.

1. A wireless transmit/receive unit (WTRU) comprising:
a transceiver; and
a processor configured to:
receive, via the transceiver, configuration information to determine beam prediction accuracy associated with an artificial intelligence or machine learning (AI/ML) model at the WTRU, wherein the configuration information comprises an indication associated with at least one transmission configuration indication (TCI) state, a first channel state information (CSI) report configuration associated with a first set of reference signal (RS) resources to predict measurements, and a second CSI report configuration associated with monitoring a second set of RS resources;
based at least on the indication of the at least one TCI state, activate the second set of reference signal (RS) resources to monitor;
start a performance evaluation counter to determine the beam prediction accuracy;
in accordance with the first CSI report configuration, predict the measurements for at least one reporting or measurement instance;
determine the beam prediction accuracy based on the configuration information, the performance evaluation counter, the first set of RS resources, and the second set of RS resources; and
send, via the transceiver, an indication of the beam prediction accuracy based at least on the second CSI report configuration and the performance evaluation counter.

2. The WTRU of claim 1, wherein a plurality of RS resource sets comprise the second set of RS resources, and wherein the processor is configured to select the second set of RS resources from the plurality of RS resource sets to activate the second set of RS resources to monitor, wherein the second set of RS resources is associated with the indication associated with the at least one TCI state.

3. The WTRU of claim 1, wherein the beam prediction accuracy represents a ratio of correctly predicted measurements to performed actual measurements for each reporting or measurement instance of the at least one reporting or measurement instance.

4. The WTRU of claim 3, wherein the processor being configured to send the indication of the beam prediction accuracy comprises the processor being configured to send an indication of the ratio of correctly predicted measurements to performed actual measurements for each reporting or measurement instance of the at least one reporting or measurement instance.

5. The WTRU of claim 3, wherein the performed actual measurements comprise actual layer-one (L1) reference signal received power (RSRP) measurements, wherein the predicted measurements comprise predicted L1-RSRP measurements, and wherein the processor being configured to determine the beam prediction accuracy comprises the processor being configured to determine whether each actual L1-RSRP measurement is within a tolerance of each predicted L1-RSRP measurement for each reporting or measurement instance of the at least one reporting or measurement instance when the performance evaluation counter is greater than threshold and the set of RS resources fails to comprise a RS resource indicated by the one or more sets of inference information.

6. The WTRU of claim 1, wherein the performance evaluation counter is started or restarted based on one or more of a radio resource configuration, reporting information, an activated CSI report configuration, or an activated reference signal (RS) resource set.

7. The WTRU of claim 1, when the performance evaluation counter is greater than threshold and the set of RS resources comprises a RS resource indicated by first CSI report configuration, the processor is configured to predict a strongest beam based on the predicted measurements, wherein the beam prediction accuracy comprises a first accuracy, wherein the first accuracy is determined when a beam with a highest measured value of the RS resource set is the strongest beam.

8. The WTRU of claim 1, when the performance evaluation counter is greater than threshold and the set of RS resources comprises a RS resource first CSI report configuration, the processor is configured to predict at least one predicted beam based on the predicted measurements, wherein the beam prediction accuracy comprises a second accuracy, wherein the second accuracy is determined when the at least one predicted beam comprises a beam with highest measured value of layer one (L1)-reference signal received power (RSRP).

9. The WTRU of claim 1, when the performance evaluation counter is greater than threshold and the set of RS resources comprises a RS resource indicated by the first CSI report configuration, wherein configuration information indicates a plurality of strong beams, wherein the beam prediction accuracy comprises a third accuracy, a fourth accuracy, or a fifth accuracy, wherein the processor is configured to:
predict at least one predicted beam based on the predicted measurements;
wherein the third accuracy, the fourth accuracy, or the fifth accuracy is determined based on the plurality of strong beams and the at least one predicted beam.

10. The WTRU of claim 1, when the performance evaluation counter is greater than threshold and the set of RS resources comprises a RS resource indicated by the first CSI report configuration, the processor is configured to predict at least one predicted beam based on the predicted measurements, wherein the beam prediction accuracy is determined based on a determination that a beam comprised in the at least one predicted beam comprises a highest layer one (L1)-reference signal received power (RSRP) value among the L1-RSRP values associated with the at least one predicted beam, and wherein the highest L1-RSRP value is within a tolerance of a highest L1-RSRP value associated with the set of RS resources.

11. A method performed by a wireless transmit/receive unit (WTRU), the method comprising:
receiving configuration information to determine beam prediction accuracy associated with an artificial intelligence or machine learning (AI/ML) model at the WTRU, wherein the configuration information comprises an indication associated with at least one transmission configuration indication (TCI) state, a first channel state information (CSI) report configuration associated with a first set of reference signal (RS) resources to predict measurements, and a second CSI report configuration associated with monitoring a second set of RS resources;
based at least on the indication of the at least one TCI state, activating the second set of reference signal (RS) resources to monitor;
starting a performance evaluation counter to determine the beam prediction accuracy;
in accordance with the first CSI report configuration, predicting the measurements for at least one reporting or measurement instance;
determining the beam prediction accuracy based on the configuration information, the performance evaluation counter, the first set of RS resources, and the second set of RS resources; and
sending an indication of the beam prediction accuracy based at least on the second CSI report configuration and the performance evaluation counter.

12. The method of claim 11, wherein a plurality of RS resource sets comprise the second set of RS resources, and wherein the method further comprising selecting the second set of RS resources from the plurality of RS resource sets to activate the second set of RS resources to monitor, wherein the second set of RS resources is associated with the indication associated with the at least one TCI state.

13. The method of claim 11, wherein the beam prediction accuracy represents a ratio of correctly predicted measurements to performed actual measurements for each reporting or measurement instance of the at least one reporting or measurement instance.

14. The method of claim 13, wherein sending the indication of the beam prediction accuracy comprises sending an indication of the ratio of correctly predicted measurements to performed actual measurements for each reporting or measurement instance of the at least one reporting or measurement instance.

15. The method of claim 13, wherein the performed actual measurements comprise actual layer-one (L1) reference signal received power (RSRP) measurements, wherein the predicted measurements comprise predicted L1-RSRP measurements, and wherein determining the beam prediction accuracy comprises determining whether each actual L1-RSRP measurement is within a tolerance of each predicted L1-RSRP measurement for each reporting or measurement instance of the at least one reporting or measurement instance when the performance evaluation counter is greater than threshold and the set of RS resources fails to comprise a RS resource indicated by the one or more sets of inference information.

16. The method of claim 11, wherein the performance evaluation counter is started or restarted based on one or more of a radio resource configuration, reporting information, an activated CSI report configuration, or an activated reference signal (RS) resource set.

17. The method of claim 11, when the performance evaluation counter is greater than threshold and the set of RS resources comprises a RS resource indicated by first CSI report configuration, the method further comprising predicting a strongest beam based on the predicted measurements, wherein the beam prediction accuracy comprises a first accuracy, wherein the first accuracy is determined when a beam with a highest measured value of the RS resource set is the strongest beam.

18. The method of claim 11, when the performance evaluation counter is greater than threshold and the set of RS resources comprises a RS resource first CSI report configuration, the method further comprising predicting at least one predicted beam based on the predicted measurements, wherein the beam prediction accuracy comprises a second accuracy, wherein the second accuracy is determined when the at least one predicted beam comprises a beam with highest measured value of layer one (L1)-reference signal received power (RSRP).

19. The method of claim 11, when the performance evaluation counter is greater than threshold and the set of RS resources comprises a RS resource indicated by the first CSI report configuration, wherein configuration information indicates a plurality of strong beams, wherein the beam prediction accuracy comprises a third accuracy, a fourth accuracy, or a fifth accuracy, wherein the method further comprising:
predicting at least one predicted beam based on the predicted measurements;
wherein the third accuracy, the fourth accuracy, or the fifth accuracy is determined based on the plurality of strong beams and the at least one predicted beam.

20. The method of claim 11, when the performance evaluation counter is greater than threshold and the set of RS resources comprises a RS resource indicated by the first CSI report configuration, the method further comprising predicting at least one predicted beam based on the predicted measurements, wherein the beam prediction accuracy is determined based on a determination that a beam comprised in the at least one predicted beam comprises a highest layer one (L1)-reference signal received power (RSRP) value among the L1-RSRP values associated with the at least one predicted beam, and wherein the highest L1-RSRP value is within a tolerance of a highest L1-RSRP value associated with the set of RS resources.
